(19) United States
(12) Patent Application Publication
(10) Pub. No.: US 2010/0280674 A1
(43) Pub. Date: Nov. 4, 2010

(54) Metering and Regulating the Distribution of Power

(76) Inventor: Reza Jalili, Sandy, UT (US)

Correspondence Address: REZA JALILI, 8463 JACKSON HOLE DR., SANDY, UT, 84093, US

(21) Appl. No.: 12/433,729

(22) Filed: Apr. 30, 2009

(51) Int. Cl. G06F 1/26; H02J 3/00; H02J 13/00; G06F 15/16

(52) U.S. Cl. 700/295; 323/318; 709/203

(57) ABSTRACT

A system for regulating the distribution of power, such as electricity, through the use of a power control mechanism (PCM). More particularly, the PCM interacts with a plug identifier that identifies a plug as an object appropriate for power usage.

### TECHNICAL FIELD

The present invention pertains to the regulation of the distribution of power, such as electricity, within a particular location or building. In particular, the present invention relates to controlling, monitoring, and measuring power distributed through an outlet.

### BACKGROUND

The distribution of power at a location, such as a house or an apartment, is monitored per the power usage of the location as a whole. While such information is sufficient for general billing purposes, it provides little insight into how the power was actually used. Although one may ascertain periods of light or heavy power usage, no data is available to account for a light or heavy demand.

Electricity is distributed within a location via a network of electrical outlets. Apart from outlets connected to wall switches, electricity is continuing and passively distributed to each outlet. While this configuration provides convenience, it does so by sacrificing safety. One can plug an appliance into any outlet in the building and can be assured that the appliance will receive power. However, because every outlet is active, there is constant potential for danger. For example, young children are often curious about electrical outlets and may place something into one and electrocute themselves. While safety plugs can deter such activity, they are not foolproof. A determined child may be able to remove a safety plug and access the active outlet. Unless the outlet is controlled by a wall switch, there is no convenient way to prevent the distribution of power to it. One could turn off a set of outlets at the circuit breaker, but one cannot pinpoint a particular outlet. For example, as a circuit breaker switch is often associated with several outlets, one cannot shut off the power to one outlet and continue power distribution to another associated with the same switch.

What is needed is a mechanism for regulating the usage of power at a location and for ensuring that power is only distributed to outlets that are in use.

### SUMMARY

The present invention addresses the aforementioned needs by providing a system for regulating the distribution of power, such as electricity, through the use of a power control mechanism (PCM). More particularly, the PCM interacts with a plug identifier that identifies a plug as an object appropriate for power usage.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an embodiment of a power distribution system in which an outlet is equipped with a PCM.

FIG. 2 illustrates an example of an embodiment of an outlet equipped with a PCM.

FIG. 3 illustrates an example of an embodiment of a plug equipped with a plug identifier.

FIG. 4 illustrates a general architecture overview of an embodiment of a power distribution system in which an outlet is not equipped with a PCM.

FIG. 5 illustrates an example of an embodiment of an outlet PCM adapter.

FIG. 6 illustrates an example of an embodiment of a plug PCM adapter.

FIG. 7 illustrates an example of an embodiment of a plug identifier adapter.

FIG. 8. illustrates a general architecture overview of an example of an implementation of the present invention.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

### Power Distribution Control

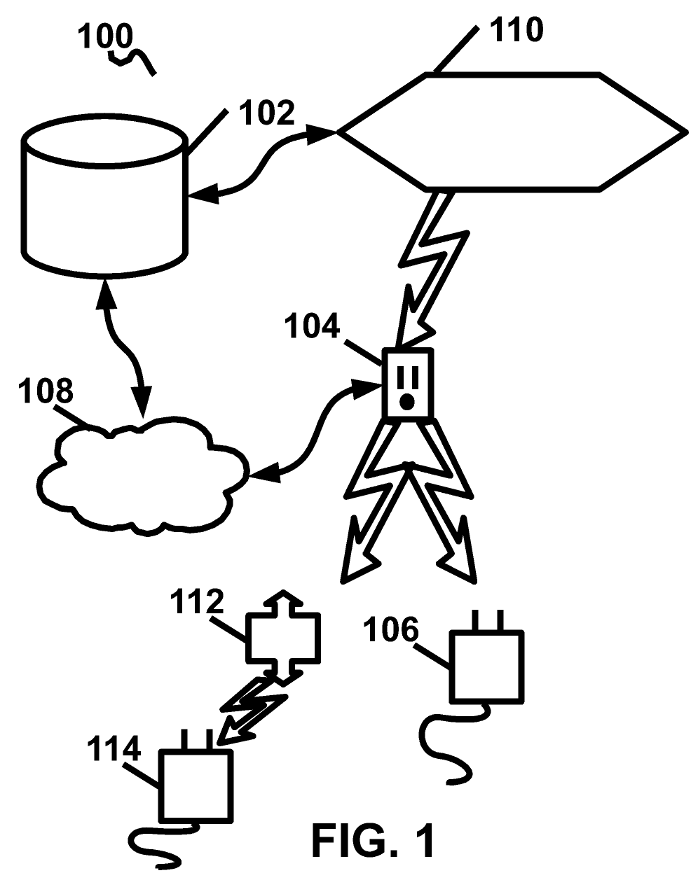

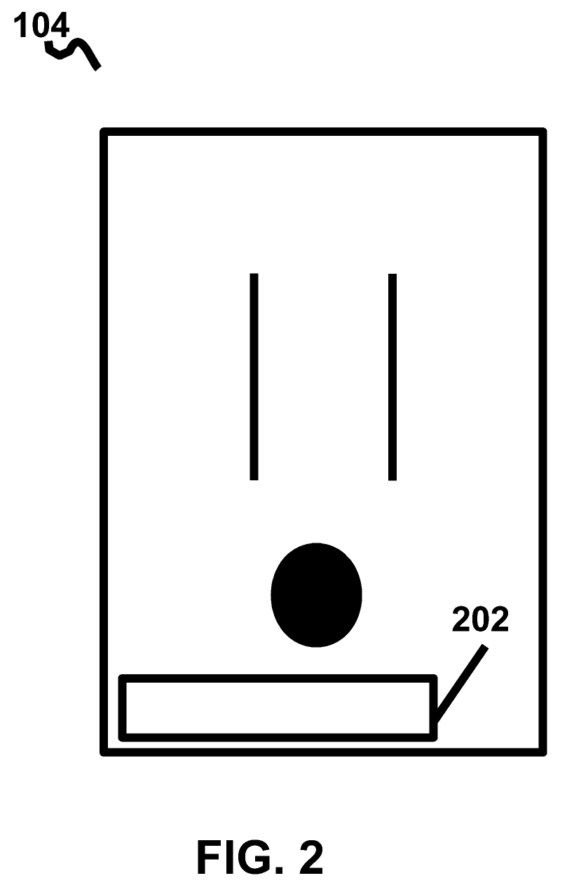

As illustrated by FIG. 1 and FIG. 2, the system 100 of the present invention can consist of one or more outlets equipped with a PCM 202, herein referred to as a “PCM outlet” 104. A PCM 202 can be an integrated circuit that regulates the flow of power from an associated power outlet to an associated power plug. Although only one PCM outlet 104 is illustrated, this is not to be construed as limiting as a location may be equipped with multiple PCM outlets 104. A location can be retrofitted to include PCM outlets 104 or PCM outlets 104 may be installed during new construction. As with a traditional outlet, a PCM outlet 104 can receive power, such as electricity, from a power source 110, thereby enabling the PCM outlet 104 to distribute the power to any appliance affixed to it. If necessary, the PCM 202 may be powered by the power source 110 or by another source, such as internal battery. As detailed below, a PCM outlet 104 may not distribute power passively, but may do so only to properly equipped plugs. The plug receptacles of a PCM outlet 104 may be different in design than a traditional outlet, thereby ensuring that only compatible plugs 106 or identifier adapters 112 are used (as detailed below). Additionally, a PCM outlet 104 can communicate via a network 108 with a control server 102, which can also communicate with the power source 110. The network 108 may employ the wiring of the location or may be a secondary network. As described below, the control server 102 can stipulate when power should be sent from the power source 110 to a PCM outlet 104 or can instruct a PCM outlet 104 to distribute power to an attached appliance. The control server 102 may monitor the power usage of each PCM outlet 104 connected to the network 108.

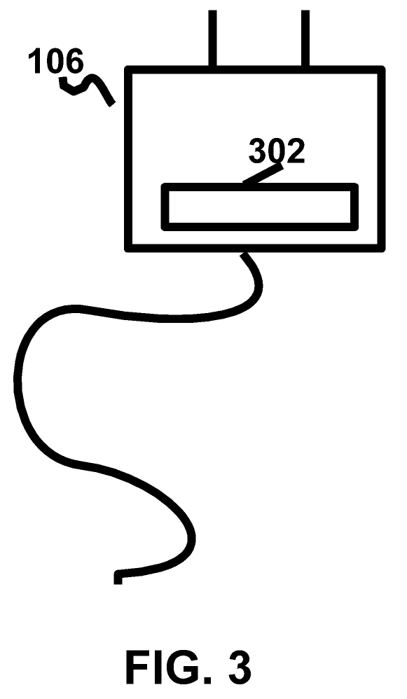

The PCM 202 may be designed to receive data from a plug identifier 302 associated with the compatible plug 106. As depicted by FIG. 3, a compatible plug 106 may be manufactured to include a plug identifier 302. The PCM 202 can interact with the plug identifier 302 contactlessly, such as via Near Field Communication (NFC). For example, the plug identifier 302 can be a radio-frequency identification (RFID) tag and the PCM 202 can include a RFID receiver. Alternatively or additionally, the PCM 202 can interact with the plug identifier 302 via contact between the compatible plug 106 and the PCM outlet 104, such as via the insertion of the compatible plug 106 into the PCM outlet 104. The PCM 202 may initiate power distribution based upon a determination of whether the compatible plug 106 is appropriate. The PCM 202 may make the determination itself or, alternatively, once the PCM 202 detects a plug identifier 302, the PCM 202 may communicate with the control server 102 and the distribution of power may be based upon the decision of the control server 102.

The appropriateness of a compatible plug 106 may be determined based solely upon the presence of the plug identifier 302; if a plug is equipped with a plug identifier 302 (i.e., it is a compatible plug 106), power may be distributed. This may ensure that power it sent to the outlet 104 only when an actual compatible plug 106 has been inserted and not, for example, upon the insertion of a foreign object (e.g., a child's finger or a piece of metal). Additionally, in order to determine whether a plug identifier 302 is appropriate, the PCM 202 may receive identifying information from the plug identifier 302. Identifying information may indicate an appliance's electronic characteristics (alternate current, direct current, watts, amps, volts, etc). The PCM 202 and/or the control server 102 can utilize such data to output the correct type of power, the correct voltage needed, and the like. In addition to, or instead of, power characteristics, the identifying information can include appliance information, such as its type (e.g., a television), manufacturer (e.g., Sony), model (e.g., Sony 32″ Bravia M-Series LCD HDTV), serial number, and the like. In one scenario, the identifying information provided by the plug identifier 302 may be a value that is used as a reference for a lookup table within the control server 102. For example, a plug identifier 302 may provide a product number that the control server 102 may use to reference data associated with a particular appliance.

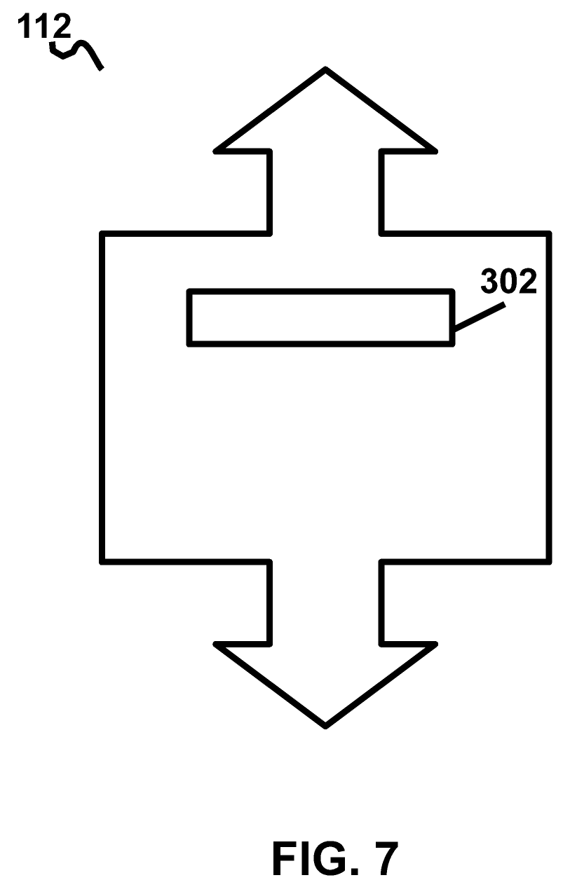

In addition to a compatible plug 106 designed for system use, a traditional plug 114 may be utilized if it is affixed with an identifier adapter 112. As illustrated by FIG. 7, an identifier adapter 112 includes a plug identifier 302. Once a traditional plug 114 is equipped with an identifier adapter 112, the PCM 202 can interact with an identifier 112 and the associated appliance as described above in relation to a compatible plug 106. The particulars of an identifier adapter 112 may vary per implementation. For example, an identifier adapter 112 may be an RFID tag that includes a plug identifier 302 and may be attached to a plug 114 via an adhesive. As another example, an identifier adapter 112 may be designed to fit a plug 114 like a conversion adapter. In one embodiment, the prongs of an identifier adapter 112 are designed to fit only the plug receptacles a PCM outlet 104 (or of a PCM adapter, as detailed below). The level of information provided by identifier adapters 112 may vary. For example, a manufacturer may provide or sell identifier adapters 112 for its appliances and such identifier adapters 112 may include specific data (e.g., manufacturer or model information). Alternatively, an identifier adapter 112 may be sold by general category and only indicate general information about the appliance (e.g., “television”). In an alternate embodiment, an identifier adapter 112 may be a specially equipped power strip and each plug receptacle of the power strip may have its own plug identifier 302, thereby allowing each affixed plug 114 to be identified. A PCM 202 may be constructed with memory and a processor enabling it to make decisions about when and how to regulate the unadjusted home electricity which is one of its inputs into the output electricity that suits the appliance plugged into an outlet that the PCM 202 controls. The circuitry for voltage regulators and transformers is well-known and readily available for integration into the overall PCM design.

### PCM Adapters

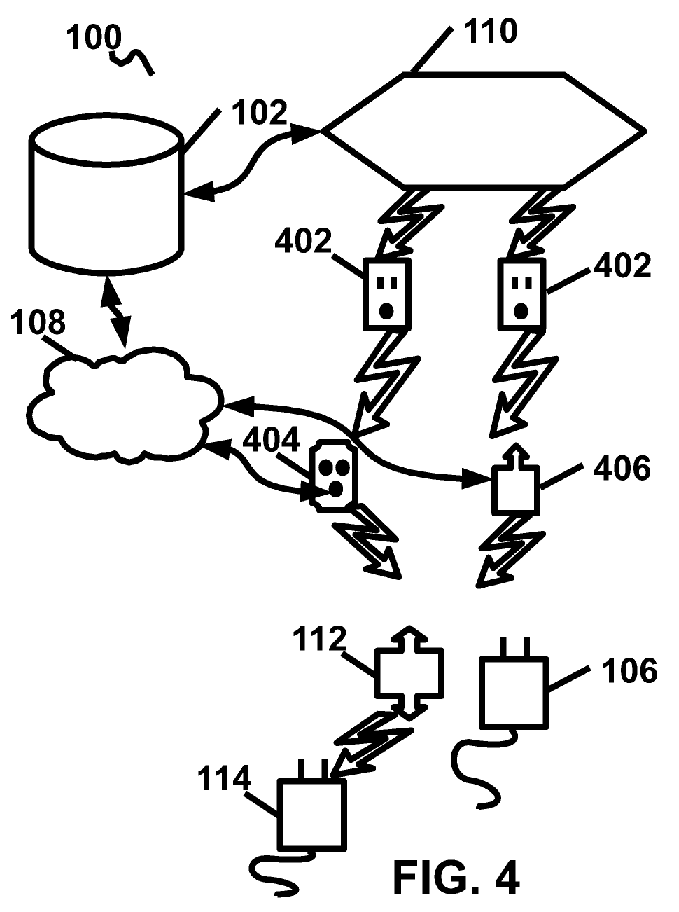

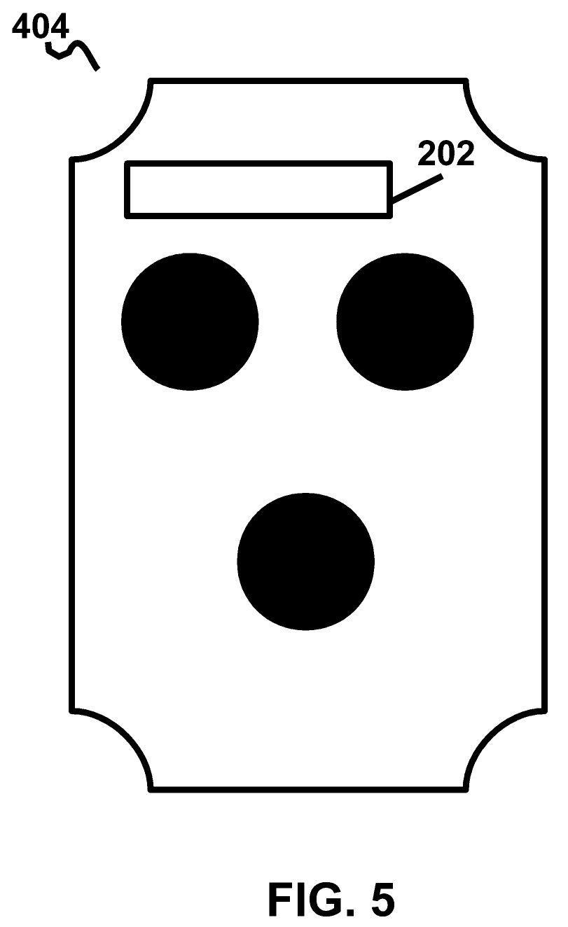

As illustrated by FIG. 4, PCM adapters may be employed to enable use of the system 100 at a location equipped with one or more traditional outlets 402. As illustrated by FIG. 5, an outlet PCM adapter can include a PCM 202, thereby enabling a traditional outlet 402 to function like a PCM outlet 104. For example, once an outlet PCM adapter 404 has been attached, the traditional outlet 402 may not be able to distribute power passively. The particulars of an outlet PCM adapter 404 can vary. For example, an outlet PCM adapter 404 may be designed to fit over the faceplate of a traditional outlet 402 or may be designed to be similar to a power strip. As with a PCM outlet 104, the plug receptacles of an outlet PCM adapter 404 may be different in design than a traditional outlet 402 to ensure use or compatible plugs 106 or identifier adapters 112. In order to enhance safety and power regulation, an outlet PCM adapter 404 may be installed on the outlet 402 permanently or with a locking mechanism in order to prevent its removal. An outlet PCM adapter 404 may be installed inside a wall for aesthetic reasons and/or to ensure durability.

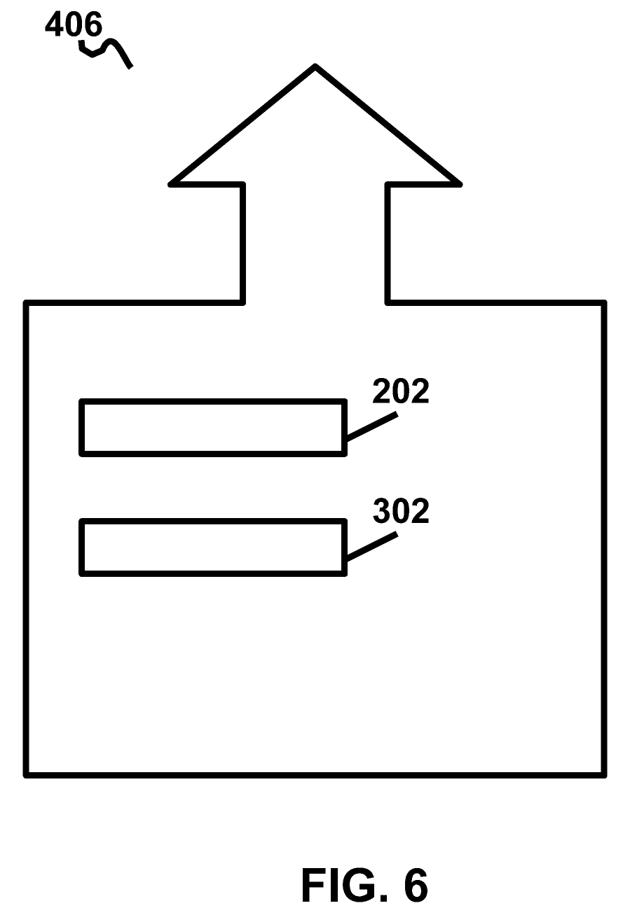

Alternatively, as illustrated by FIG. 6, a PCM adapter may be a plug PCM adapter 406. A plug PCM adapter 406 can operate similarly to an outlet PCM adapter 404, but modify a plug (e.g., a traditional plug 114 or a compatible plug 106) rather than a traditional outlet 402. If both a traditional outlet 402 and a traditional plug 114 are employed, an individual may equip the traditional plug 114 with both an identifier adapter 112 and a plug PCM adapter 406. Alternatively, the plug PCM adapter 406 may include a plug identifier 302, thereby alleviating the need to affix a traditional plug 114 with both adapters. Like the aforementioned identifier adapter 112, a plug PCM adapter 406 can be designed like a conversion adapter.

Regardless of whether an outlet PCM adapter 404 or a plug PCM adapter 406 is employed, once the PCM adapter is in place, the system 100 may function as previously described in relation to a PCM outlet 104.

### Power Distribution Information Gathering

In addition to regulating the distribution of power, the system 100 can enable the gathering of data regarding the usage of power. As aforementioned, a PCM 202 can receive identifying information from a plug identifier 302. The PCM 202 can relay this information to a control server 102 for storage. The control server 102 can be located and managed by the power company and/or each location, for example, a home, may have its own control server 102. For example, a house could have its own control server 102. In one embodiment, a multi-purpose device, such as a personal computer (e.g., desktop computer, laptop computer, etc.) or a mobile device (e.g., mobile phone, PDA, etc.), can serve as the control server 102. Information received by the control server 102 can be viewed via software, thereby allowing such data to be analyzed. For example, a homeowner can obtain a real-time view of power usage in his house. The user can ascertain how much power each appliance uses and the associated cost. By doing so, one may determine which appliances are most efficient, which appliances use the majority of the power, and the like. The information gathered by the control server 102 can be aggregated and shared with other interested parties. For example, a user may upload it to a social networking Web site or a power company may provide the data to appliance manufacturers. In one scenario, one can analyze data received from control servers 102 across a particular region in order to determine consumption trends. For example, one could determine how many GE refrigerators are being used in the United States at a given time, or one could compare one's television's energy usage against that of other individuals. A network 108 can enable a control server 102 to receive information from a PCM 202 wirelessly using standard wi-fi means or on-the-wire through the building-wide electrical wiring of the site of the control server 102.

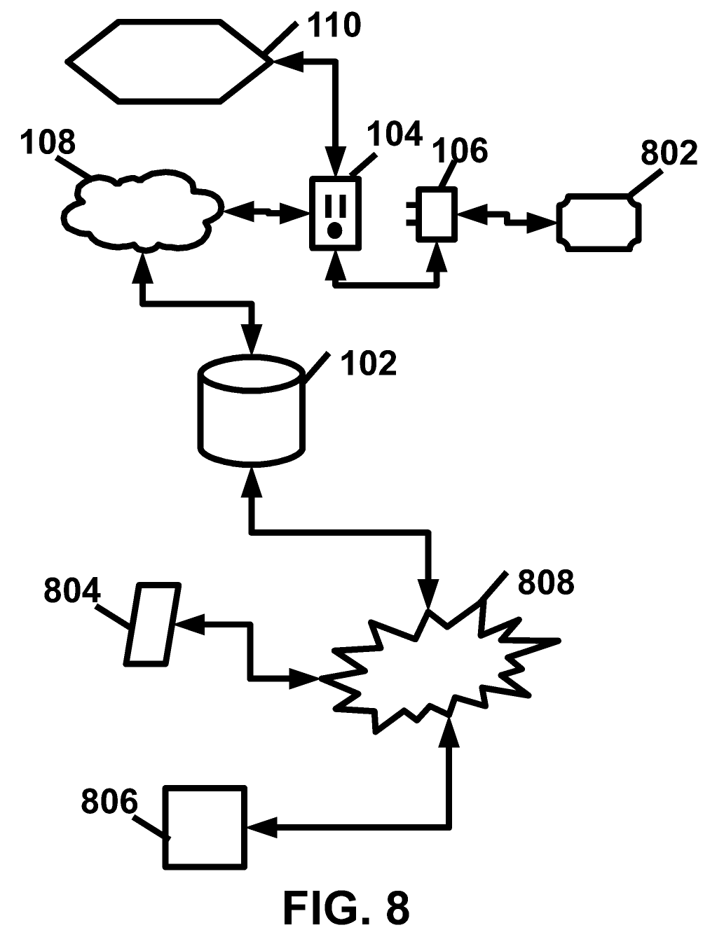

FIG. 8. depicts an illustrative example of an implementation of the present invention. For example, in a home, the source wires from the utility provider coming into the house can connect to wires that connect to PCMs 202 throughout the house (e.g., network 108). Each PCM 202 can be installed behind a wall, as a traditional outlet is today, and each can expose to the inside of the home a receptacle for plugging in an appliance 802. A PCM outlet 104 can have internal circuitry to control the flow of electricity as commonly available in DC converters for electronic devices and also circuitry for shutting off electric power to an attached appliance completely. The default state of the PCM outlet 104 is to provide no electrical connection between a coupled appliance 802 and the electricity source behind the PCM outlet 102, that is, the leads on the outlet are not electrified until an identified appliance is coupled and the PCM calculates to turn on power or a signal from the control server 202 instructs a PCM to turn on power. Once an appliance 802 is coupled to the PCM outlet 104, for example, by inserting the appliance's plug (e.g., a compatible plug 106) into the outlet holes, the PCM 202 is triggered to identify the coupled appliance 802. The identification step can make use of an RFID tag (e.g., a plug identifier 302) inside the appliance plug. The RFID tag provides information about the appliance's power requirements. The PCM 202 may use the electrical wiring of the home to communicate with a control server 102 and send a message using standard message protocols, for example, TCP/IP. The message may inform the control server 102 that the PCM 202, identified by a number or other label, is about to turn on electricity for an appliance 802 and the RFID tag information can be supplied to the control server 102. Based on the configuration of the PCM 202, the PCM 202 may either immediately turn on power to the appliance 802 or await a message from the control server 102 with more specific instructions, such as “do not power this appliance” or “power this appliance only for 10 minutes.” The control server 102 and each PCM 202 may be configured via a mechanism similar to the kind used to configured a modern home Internet router. For example, a built-in web-server interface can allow a home owner to point a web browser to a particular IP address and to access the configuration screen and control the control server 102 and each PCM 202. In one embodiment, the network 108 can be a wireless network on site allows the control server 102 to communicate with a laptop application that shows graphically the total power coming into the home, the total power used broken down by appliance, by outlet and location in the home, by time, by type of appliance (e.g., computer, air conditioning unit, refrigerator, tv, etc.), and the like. The power data collected and generated by a control server 102 and by each PCM 202 can be shared with the home owner and with anyone else using the Internet 808 and one or more service Web sites 806, such as Facebook.com or the like. With the communication abilities of the control server 102 and some standard security measures, such as a userid and password, a homeowner can control and monitor power usage remotely. For example, an individual may employ a mobile device 804 to monitor the power usage of his home.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

1. A system for the distribution of power through an outlet, the system comprising:
an outlet, wherein the outlet enables the distribution of power from a power source to a plug;
a plug, wherein the plug enables the distribution of power received from the outlet to an appliance;
a power control mechanism that controls the distribution of power from the power outlet to the plug; and
a plug identifier, wherein the plug identifier provides data at least indicative of system compliance of an associated plug to the power control mechanism.

2. The system of claim 1, wherein the power control mechanism and the plug identifier communicate contactlessly.

3. The system of claim 1, wherein the power control mechanism and the plug identifier communicate via contact.

4. The system of claim 1, wherein the power control mechanism is affixed to the outlet.

5. The system of claim 1, wherein the power control mechanism is affixed to the plug.

6. The system of claim 1, wherein the plug includes the plug identifier.

7. The system of claim 1, further comprising an identifier adapter.

8. The system of claim 7, wherein the identifier adapter includes the plug identifier.

9. The system of claim 1, further comprising a control server.

10. The system of claim 9, wherein the control server initiates the distribution of power by communicating with the power control mechanism.

11. The system of claim 9, wherein the control server records data about power distributed through an outlet.

12. The system of claim 9, wherein the control server records data about power distributed to a plug.

13. A method for monitoring power usage comprising the steps of receiving power usage data from an outlet and aggregating power usage data from a plurality of outlets.

14. A method for monitoring power usage as in claim 13, further comprising the steps of publishing power usage data from an outlet.

15. A method as in claim 13, further comprising publishing aggregated power usage data.

16. A method as in claim 13, enabled by a plurality of storage devices, wherein said power usage data is shared between said plurality of storage devices, whereby human members of a social network may view and learn from one another, and whereby members of an electronic network may use power usage data associated with another member.

17. A method for regulating power usage comprising the steps of (a) receiving at a control server, power data, (b) calculating the power to be delivered, (c) and delivering a calculated level of power, wherein said power data comprises at least one of (i) outlet identifier, (ii) appliance identifier (iii) voltage (iv) current (v) duration (vi) ac/dc indication.

18. A power control server device enabled to receive power data from a plurality of coupled appliances, whereby power delivered to each of said coupled appliances is controlled by said power control server.
